(19) United States
(12) Patent Application Publication
(10) Pub. No.: US 2016/0345332 A1
(43) Pub. Date: Nov. 24, 2016

(54) TIME DOMAIN DUPLEXING CONFIGURATON FOR eIMTA

(71) Applicant: QUALCOMM INCORPORATED, San Diego, CA (US)

(72) Inventors: Peng CHENG, Beijing (CN); Neng WANG, Beijing (CN); Chao WEI, Beijing (CN); Wanshi CHEN, San Diego, CA (US); Peter GAAL, San Diego, CA (US); Hao XU, San Diego, CA (US); Jilei HOU, Being (CN)

(21) Appl. No.: 15/112,576

(22) PCT Filed: Feb. 20, 2015
(86) PCT No.: PCT/CN2015/073237

§ 371 Date: Jul. 19, 2016

(30) Foreign Application Priority Data
Feb. 20, 2014 (CN) PCT/CN2014/072295

(51) Int. Cl. H04W 72/04; H04L 5/14; H04L 5/00

(52) U.S. Cl. CPC H04W 72/0486; H04L 5/001; H04L 5/14; H04W 84/042

(57) ABSTRACT

The present disclosure relates generally to wireless communication, and more particularly, to methods and apparatus for dynamic time domain duplexing (TDD) subframe configurations.

### CLAIM OF PRIORITY

The present Application for Patent claims priority to International application No. PCT/CN2014/072295, filed 20 Feb. 2014, which is assigned to the assignee hereof and expressly incorporated herein by reference.

### FIELD

The present disclosure relates generally to wireless communication, and more particularly, to methods and apparatus for time domain duplexing (TDD) subframe configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communications by a base station. The method generally includes participating in communications with a user equipment (UE) in a system that supports carrier aggregation (CA) and dynamic uplink and downlink subframe configuration based on traffic load; configuring the UE with a first reference subframe configuration for communications on a primary component carrier (PCC), wherein the first subframe configuration is selected from a first set of subframe configurations; and configuring the UE with a second reference subframe configuration for communications on a secondary component carrier (SCC), wherein the second reference subframe configuration has a greater number of subframes designated as uplink subframes than any reference subframe configuration in the first set of subframe configurations.

Certain aspects of the present disclosure provide a method for wireless communications by a user equipment. The method generally includes participating in communications with a base station (BS) in a system that supports carrier aggregation (CA) and dynamic uplink and downlink subframe configuration based on traffic load; receiving signaling configuring the UE with a first reference subframe configuration for communications on a primary component carrier (PCC), wherein the first subframe configuration is selected from a first set of subframe configurations; and receiving signaling configuring the UE with a second reference subframe configuration for communications on a secondary component carrier (SCC), wherein the second reference subframe configuration has a greater number of subframes designated as uplink subframes than any reference subframe configuration in the first set of subframe configurations.

Certain aspects of the present disclosure provide an apparatus for wireless communications. The apparatus generally includes means for participating in communications with a user equipment (UE) in a system that supports carrier aggregation (CA) and dynamic uplink and downlink subframe configuration based on traffic load, means for configuring the UE with a first subframe configuration for communications on a primary component carrier (PCC), wherein the first subframe configuration is selected from a first set of subframe configurations, and means for configuring the UE with a second subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

Certain aspects of the present disclosure provide an apparatus for wireless communications. The apparatus generally includes means for participating in communications with a base station (BS) in a system that supports carrier aggregation (CA) and dynamic uplink and downlink subframe configuration based on traffic load, means for receiving signaling configuring the UE with a first subframe configuration for communications on a primary component carrier (PCC), wherein the first subframe configuration is selected from a first set of subframe configurations, and means for receiving signaling configuring the UE with a second reference subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

Certain aspects of the present disclosure provide an apparatus for wireless communications. The apparatus generally includes at least one processor configured to participate in communications with a user equipment (UE) in a system that supports carrier aggregation (CA) and dynamic uplink and downlink subframe configuration based on traffic load, configure the UE with a first subframe configuration for communications on a primary component carrier (PCC), wherein the first subframe configuration is selected from a first set of subframe configurations, and configure the UE with a second subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

Certain aspects of the present disclosure provide an apparatus for wireless communications. The apparatus generally includes at least one processor configured to participate in communications with a base station (BS) in a system that supports carrier aggregation (CA) and dynamic uplink and downlink subframe configuration based on traffic load, receive signaling configuring the UE with a first subframe configuration for communications on a primary component carrier (PCC), wherein the first subframe configuration is selected from a first set of subframe configurations, and receive signaling configuring the UE with a second reference subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

100111 Certain aspects of the present disclosure provide a computer-readable storage medium for wireless communications. The computer-readable storage medium generally includes code for participating in communications with a user equipment (UE) in a system that supports carrier aggregation (CA) and dynamic uplink and downlink subframe configuration based on traffic load; configuring the UE with a first reference subframe configuration for communications on a primary component carrier (PCC), wherein the first subframe configuration is selected from a first set of subframe configurations; and configuring the UE with a second reference subframe configuration for communications on a secondary component carrier (SCC), wherein the second reference subframe configuration has a greater number of subframes designated as uplink subframes than any reference subframe configuration in the first set of subframe configurations.

Certain aspects of the present disclosure provide a computer-readable storage medium for wireless communications. The computer-readable storage medium generally includes code for participating in communications with a base station (BS) in a system that supports carrier aggregation (CA) and dynamic uplink and downlink subframe configuration based on traffic load; receiving signaling configuring the UE with a first reference subframe configuration for communications on a primary component carrier (PCC), wherein the first subframe configuration is selected from a first set of subframe configurations; and receiving signaling configuring the UE with a second reference subframe configuration for communications on a secondary component carrier (SCC), wherein the second reference subframe configuration has a greater number of subframes designated as uplink subframes than any reference subframe configuration in the first set of subframe configurations.

Aspects generally include methods, apparatus, systems, computer program products, and processing systems, as substantially described herein with reference to and as illustrated by the accompanying drawings. “LTE” refers generally to LTE and LTE-Advanced (LTE-A).

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates a list of uplink/downlink subframe configurations.

FIG. 8 illustrates an example subframe frame format.

FIG. 9 illustrates subframe scheduling in accordance with certain aspects of the present disclosure.

FIG. 10 illustrates example operations for wireless communications by a base station, in accordance with certain aspects of the present disclosure.

FIG. 11 illustrates example operations for wireless communications by a UE, in accordance with certain aspects of the present disclosure.

FIG. 12A illustrates an example subframe configuration in accordance with certain aspects of the present disclosure.

FIG. 12B illustrates an example subframe configuration in accordance with certain aspects of the present disclosure.

FIGS. 13A illustrates performance increases associated with the UL-heavy TDD configurations

FIGS. 13B illustrates performance increases associated with the UL-heavy TDD configurations

FIG. 14A illustrates different scenarios that may exist to alleviate the potential issues with HARQ and scheduling information when using an UL-heavy TDD configuration.

FIGS. 14B illustrates different scenarios that may exist to alleviate the potential issues with HARQ and scheduling information when using an UL-heavy TDD configuration.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Existing LTE standards define seven uplink (UL)/downlink (DL) subframe configurations to be used with time division duplexing (TDD) operation. While the existing seven UL/DL subframe configurations are adequate to handle most traffic loading scenarios, they may not be adequate to handle heavy UL traffic loading. Thus, aspects of the present disclosure present techniques for wireless communication using subframe configurations designed to handle scenarios in which UL traffic loading is heavy.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

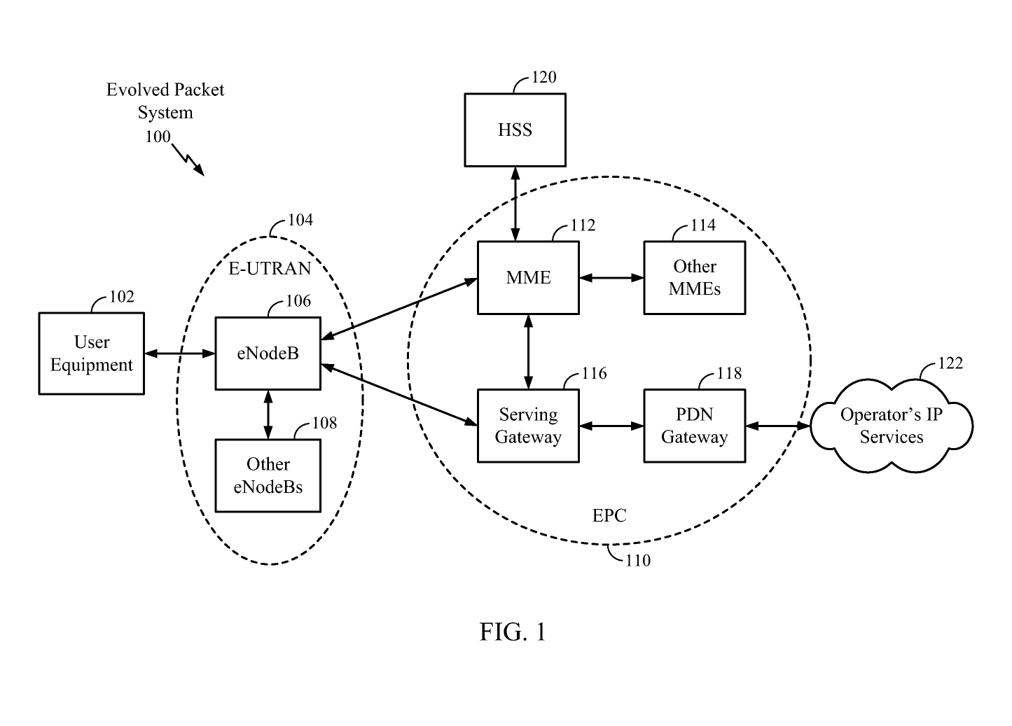

FIG. 1 is a diagram illustrating an LTE network architecture 100, in which aspects of the present disclosure may be performed. For example, user equipment 102 and/or eNodeBs 106 and 108 may utilize the techniques described herein to communicate using uplink heavy subframe configurations.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network.

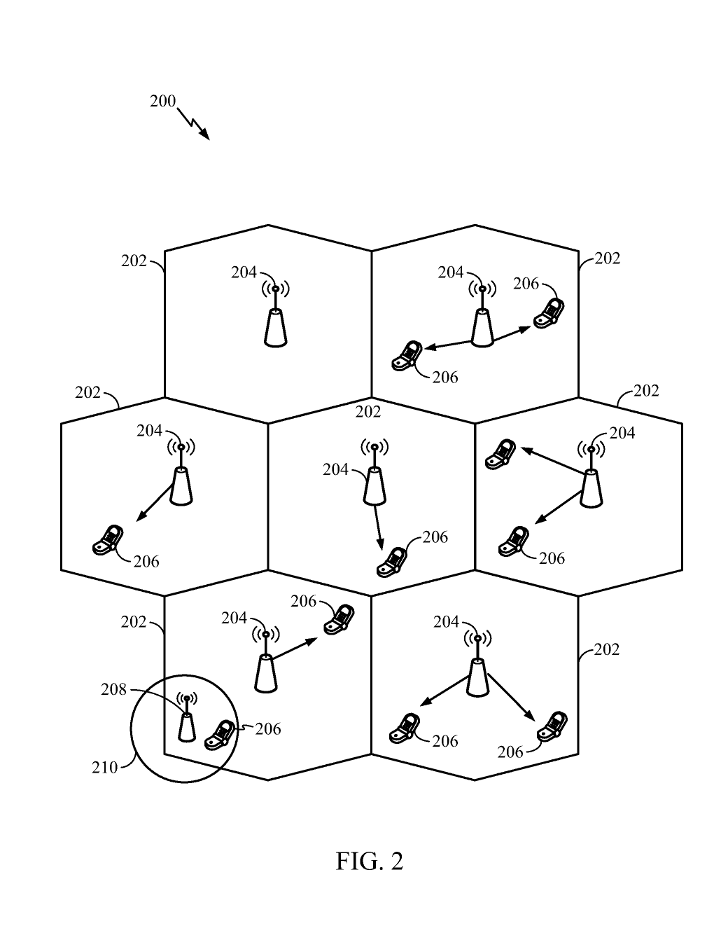

FIG. 2 is a diagram illustrating an example of an access network 200 in an LTE network architecture, in which aspects of the present disclosure may be performed. For example, user equipments 206 and/or eNodeBs 204 and 208 may utilize the techniques described herein to communicate using uplink heavy subframe configurations.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, an UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20,and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

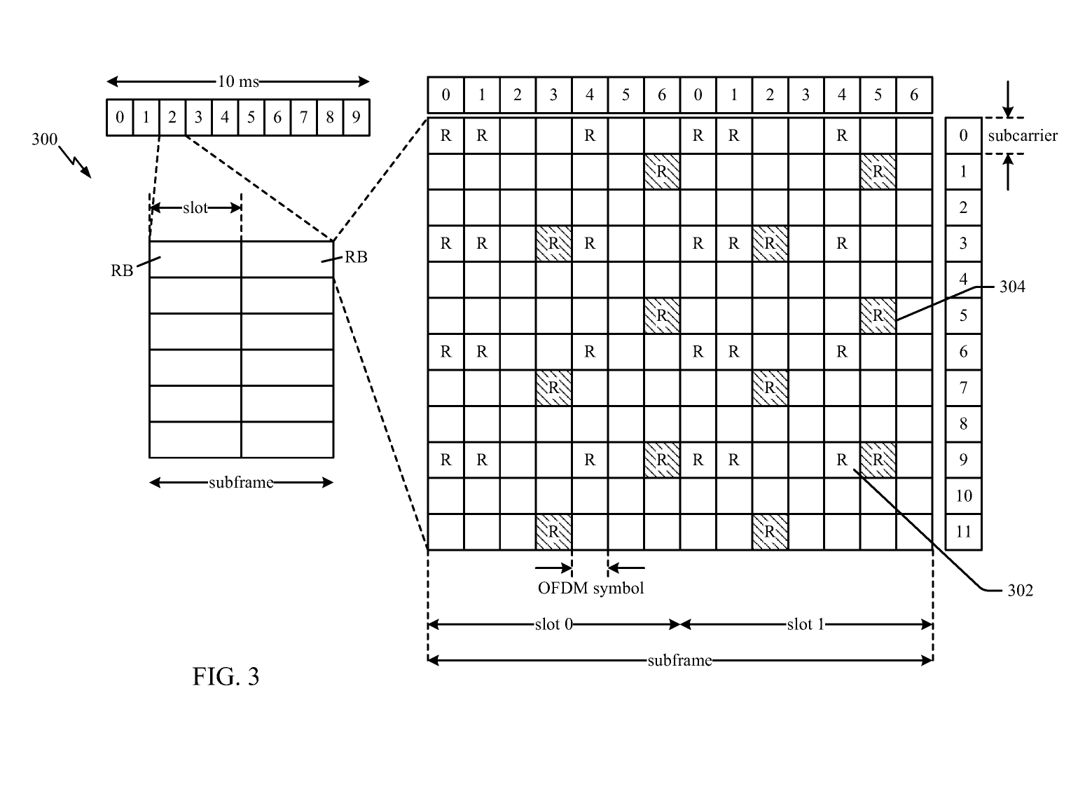

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

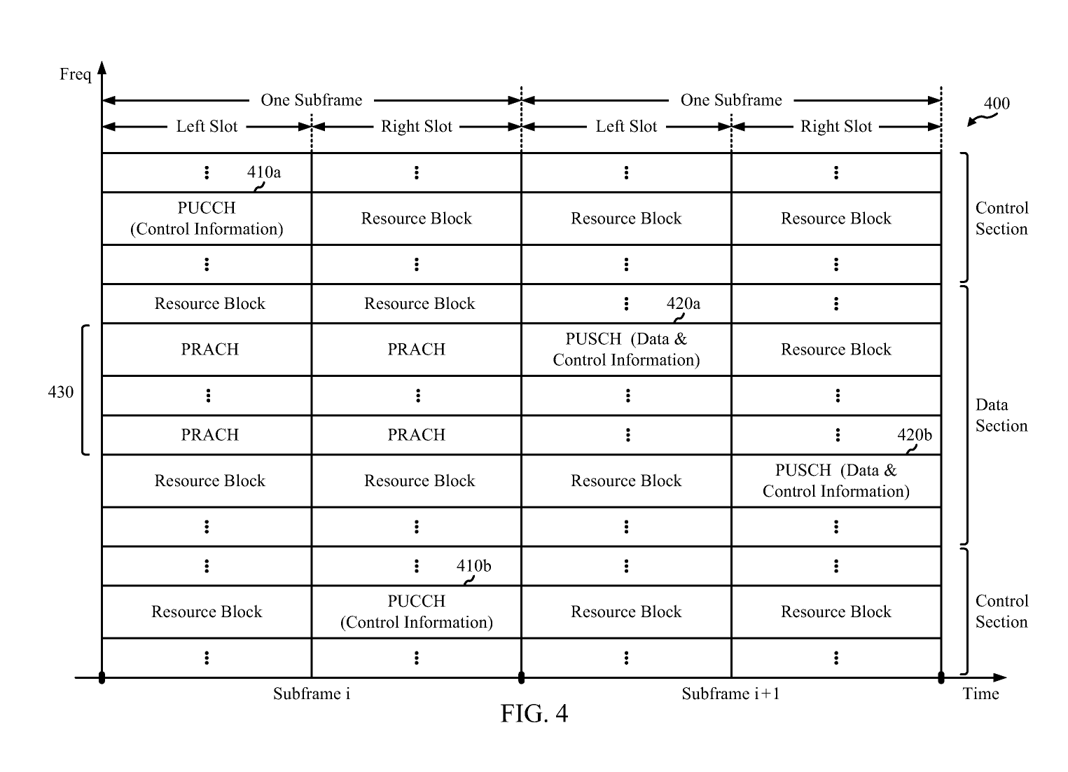

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

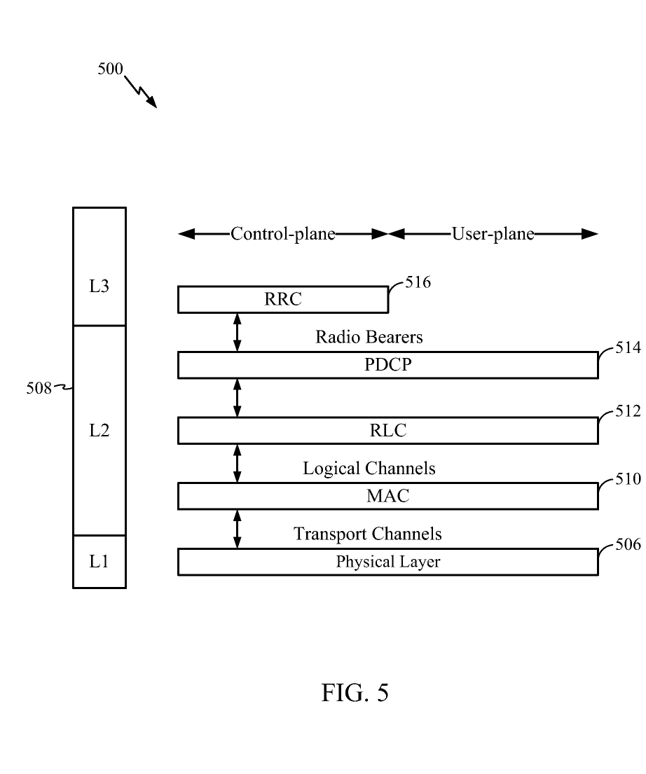

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

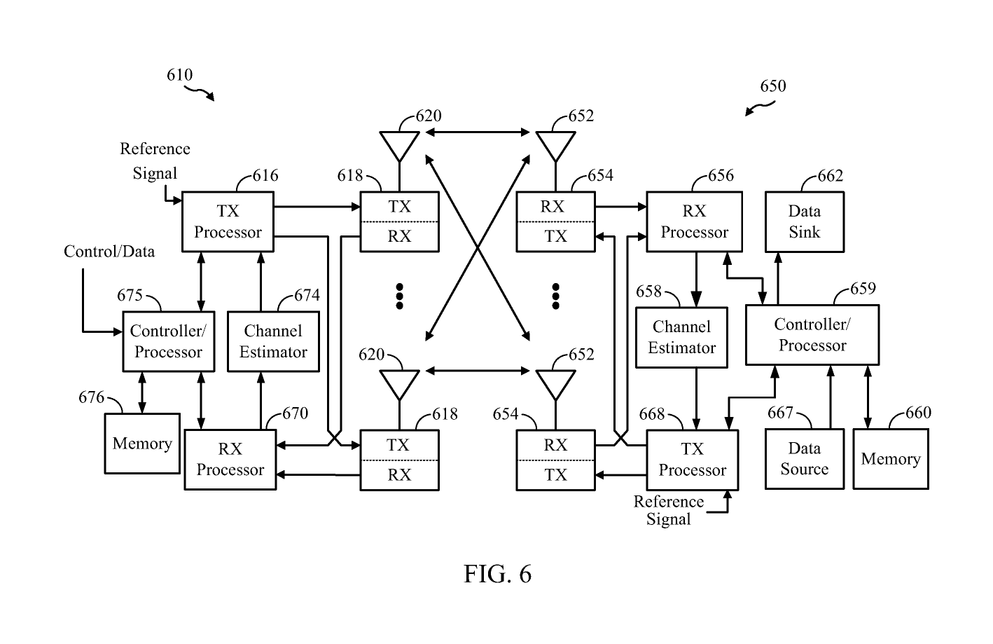

FIG. 6 is a block diagram of an eNB 610 in communication with a UE 650 in an access network, in which aspects of the present disclosure may be performed. For example, user equipment 650 and/or eNodeBs 610 may utilize the techniques described herein to communicate using uplink heavy subframe configurations.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

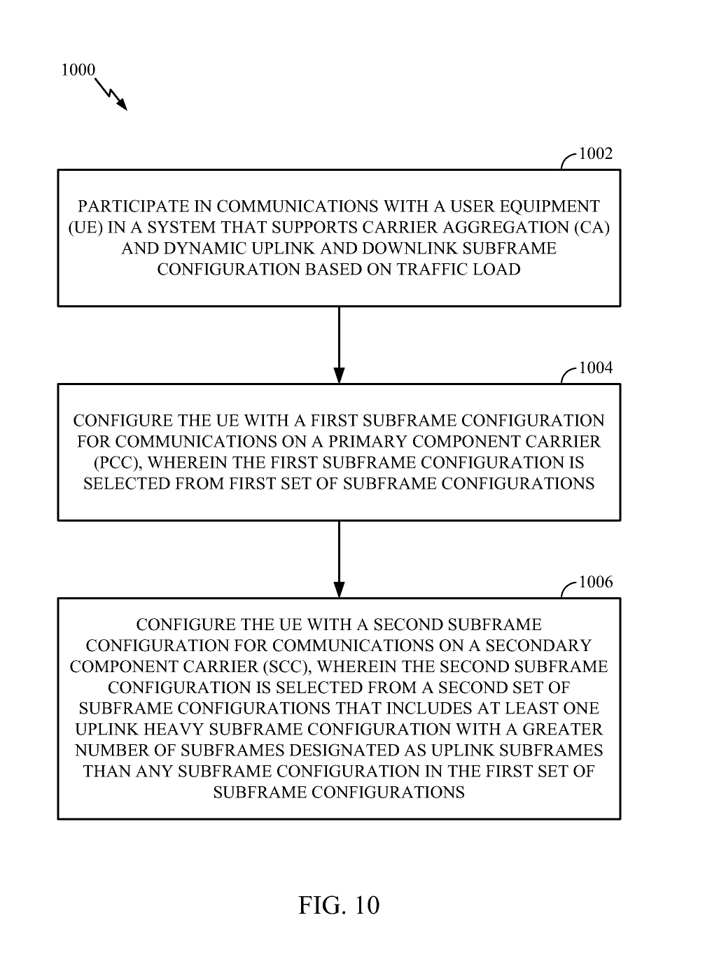

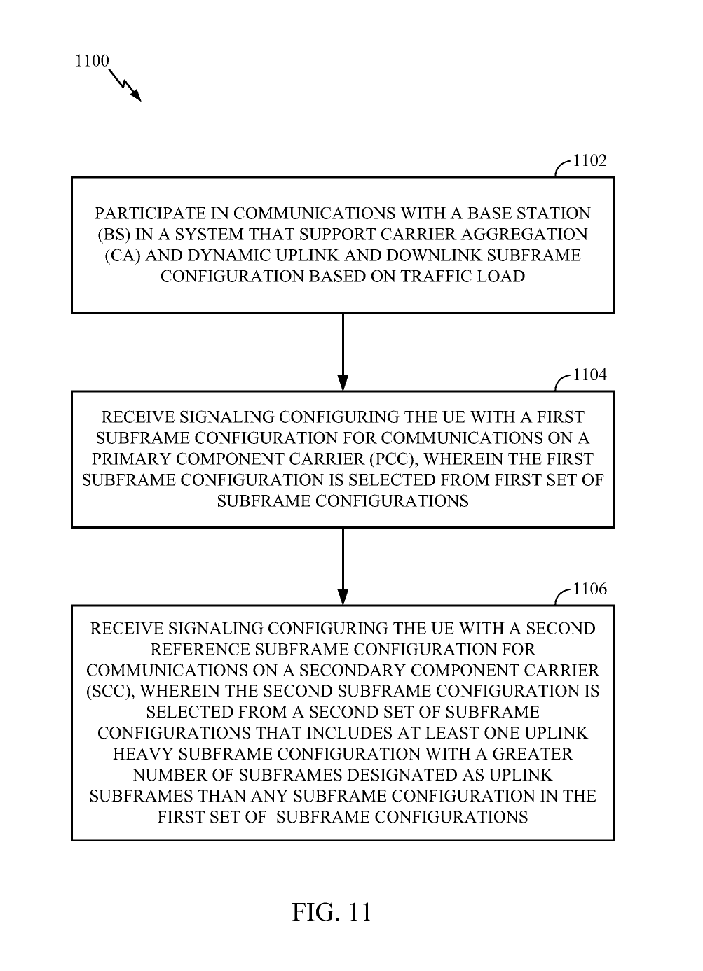

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operation at the eNB 610 and the UE 650, respectively. The controller/processor 659 and/or other processors and modules at the UE 650 may perform or direct operations for example operations 1100 in FIG. 11, and/or other processes for the techniques described herein, for example. The controller/processor 675 and/or other processors and modules at the eNB 610 may perform or direct operations for example operations 1000 in FIG. 10, and/or other processes for the techniques described herein, for example. In aspects, one or more of any of the components shown in FIG. 6 may be employed to perform example operations 1000 and 1100 and/or other processes for the techniques described herein.

### Example Subframe Configurations

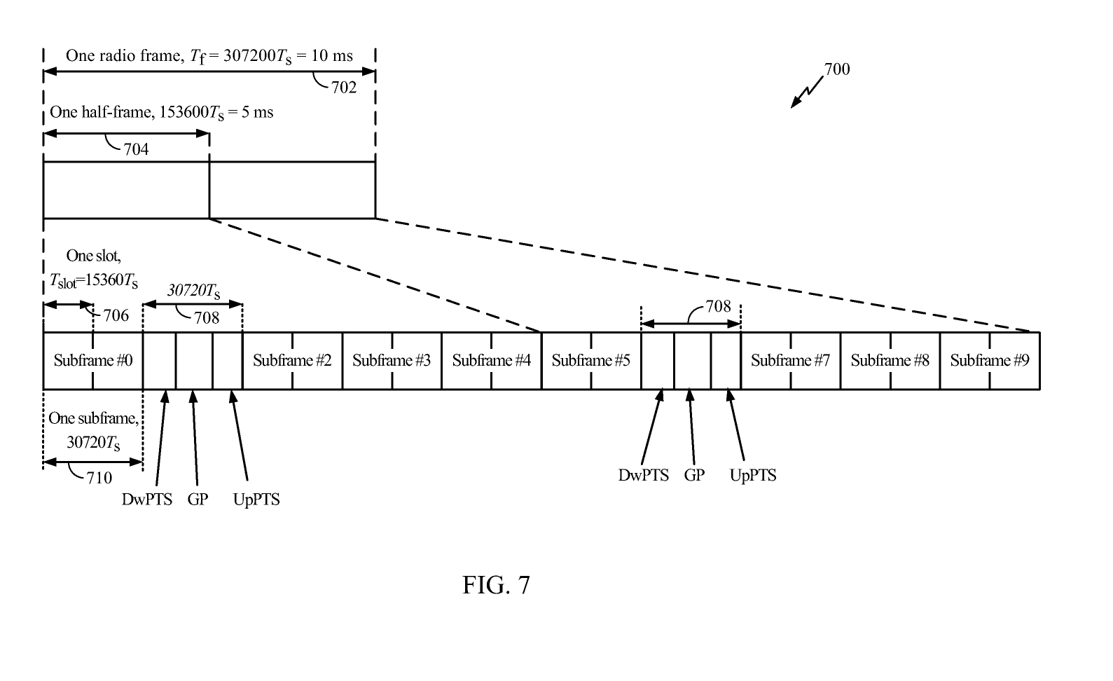

FIG. 7 shows an example frame structure 700 for LTE TDD. As shown in FIG. 7, the 10 ms radio frame 702 consists of two half frames 704 of equal length (e.g., 5 ms), with each half frame consisting of 10 slots or 8 slots (e.g. slot 706) plus three special fields DwPTS (downlink pilot time slot, GP (guard period), and UpPTS (uplink pilot time slot) in a special subframe 708. Each slot 706 is 0.5 ms in length and two consecutive slots form exactly one subframe 710.

Within a radio frame, LTE TDD switches multiple times between downlink and uplink transmission and vice versa. The guard period (GP) is inserted between DwPTS and UpPTS when switching from the downlink to the uplink. The duration of the GP depends on the signal propagation time from a base station to a mobile station and back, as well as the time the mobile station requires to switch from receiving to sending. The lengths of the individual special fields depend on an uplink/downlink configuration selected by the network, but the total length of the three special fields remains constant at 1 ms.

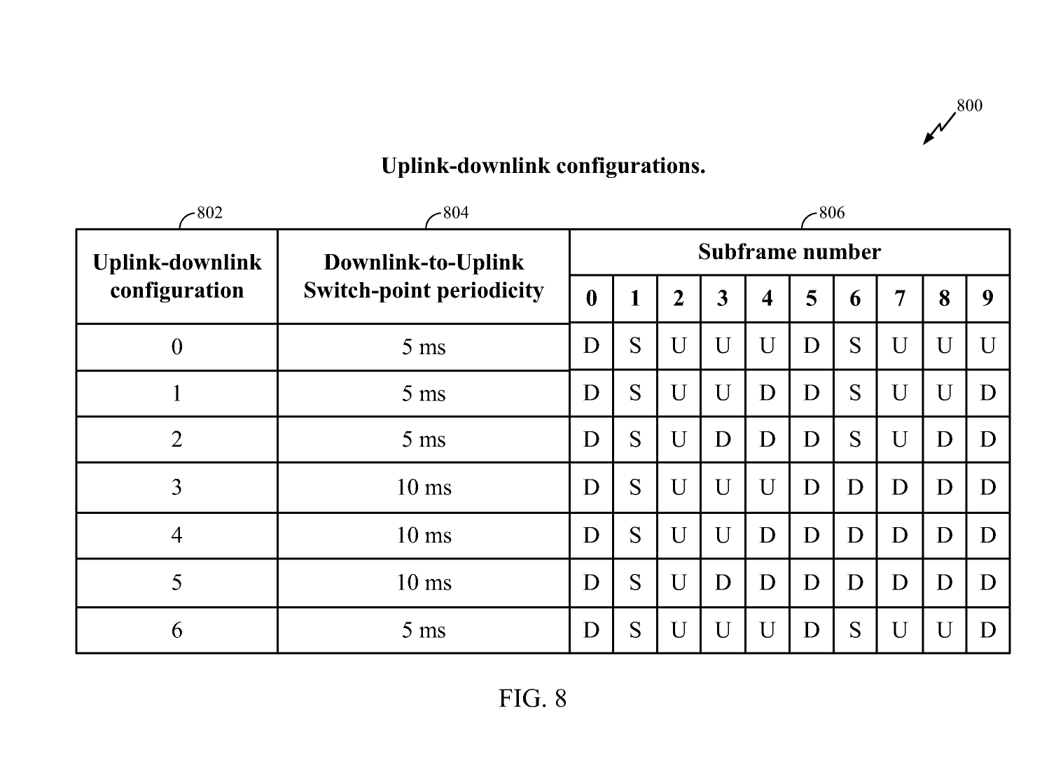

In LTE TDD, transmission directions are separated by carrying the UL and DL data in different subframes. Seven possible DL and UL subframe configurations are supported, as shown in Table 800 of FIG. 8.

As shown in column 802 of table 800, the 7 UL/DL configurations are identified by indices 0-6. As shown in column 806, a “D” in a subframe indicates DL data transmission, “U” indicates UL data transmission, and “S” indicates a special subframe having special fields DwPTS, GP, and UpPTS as discussed above with reference to FIG. 7. As shown in column 804, there are 2 switching periodicities, 5ms and 10 ms. For 5ms periodicity (e.g., subframe configurations 0-2 and 6), there are two special subframes in one 10 ms frame—as illustrated in FIG. 7. For 10 ms periodicity (e.g., subframe configurations 3-5), there is one special subframe in one frame.

### Time Division Duplexing Configuration for eIMTA

In LTE RAN1 there is a new approved release 12 WI which details further enhancements to LTE TDD for DL-UL interference management and traffic adaptation (eIMTA). The eIMTA scheme may allow adaptation of DL versus UL resource allocation according to cell traffic loading.

As illustrated in table 800 in FIG. 8, seven different subframe configurations are specified for LTE TDD systems. Feasibility studies and performance evaluation of eIMTA in various scenarios show significant gains for dynamic subframe reconfiguration for traffic adaptation when the DL and UL load is different. The gain may be highly dependent on adaptation rate. For example, the gain may be highly dependent on the adaption rate, such as 10 ms, 200 ms and 640 ms corresponding to Layer 1 (L1), Radio Resource Control (RRC) and broadcast signaling. A fast adaptation time scale (e.g., 10 ms) on frame basis provides the maximum performance gains.

Generally, when using eIMTA, the actual usage of a subframe can be subject to eNB scheduling. For example, depending on eNB scheduling, subframes 3, 4, 5, 7, 8, 9 may be either DL or UL subframes, while subframes 6 may be either DL or special subframes.

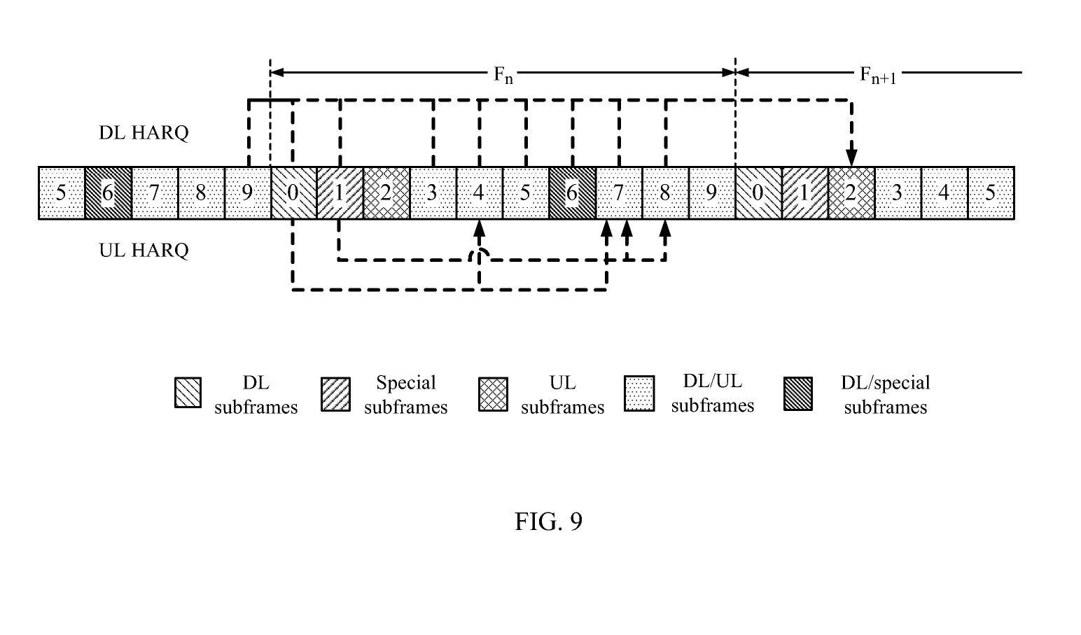

To simplify the operations for eIMTA, it may be possible to define one or more DL/UL configurations as a reference for many physical layer operations. For example, as illustrated in FIG. 9, DL Hybrid Automated Repeat Request (HARQ) operations may be based on DL/UL subframe configuration #5, regardless of the actual DL/UL subframe configuration in use in a frame (or half a frame). That is, if dynamic DL/UL subframe configuration is enabled, the DL HARQ timing may be based on the 9:1 DL/UL subframe configuration. For example, as shown in FIG. 9, the DL HARQ timing may be based on subframe configuration #5 (i.e., DSUDDDDDDD), in which downlink transmissions in subframes 0, 1, 3, 4, 5, 7, and 8 of frame Fₙ are acknowledged in uplink subframe 2 of frame Fₙ₊₁.

At the same time, UL HARQ operation may be based on DL/UL subframe configuration #0, for example, regardless of the actual DL/UL subframe configuration in use in a frame (or half a frame), also illustrated in FIG. 9. That is, if dynamic DL/UL subframe configuration is enabled, the UL HARQ timing may be always based on the 4:6 DL/UL subframe configuration. For example, as shown in FIG. 9, the UL HARQ timing may be based on subframe configuration #0 (i.e., DSUUUDSUUU), in which if a UE receives an ACK/NACK in a Physical Hybrid-ARQ Indicator Channel (PHICH) in subframe 0 of frame Fₙ the UE may retransmit the data associated with that ACK/NACK in subframe 4 (if the most significant bit (MSB) of the UL index in DCI format 0 is set to 1) or subframe 7 (if the least significant bit (LSB) of the UL index is set to 1) of frame Fₙ. Additionally, as shown, if the UE receives an ACK/NACK in the PHICH in subframe 1 of frame Fₙ the UE may retransmit the data associated with that ACK/NACK in subframe 7 (if the MSB of the UL index in DCI format 0 is set to 1) or subframe 8 (if the LSB of the UL index is set to 1).

While the existing seven UL-DL configurations illustrated in FIG. 8 may be useful in a variety of situations, these configurations may not be adequate to handle an UL-heavy scenario since the maximum UL subframe portion in each existing configuration is, at most, only 60 percent of the total subframes in a frame (e.g.., configuration #0). That is, in a scenario with UL-heavy loading, none of the existing seven configurations may be adequate to handle the heavy amount of UL traffic. Thus, there is a need for new subframe configurations that are able to accommodate a heavy amount of UL traffic, thus improving UL performance in eIMTA.

FIG. 10 illustrates example operations 1000 for wireless communications (e.g., communicating using a UL-heavy subframe configuration), in accordance with aspects of the present disclosure. According to aspects, the operation 1000 may be performed by an eNB (e.g., eNBs 106, 204, 208, and/or 610).

The operations 1000 begin, at 1002, by participating in communications with a user equipment (UE) in a system that supports carrier aggregation (CA) and dynamic uplink and downlink subframe configuration based on traffic load. At 1004, the base station configures the UE with a first subframe configuration for communications on a primary component carrier (PCC), wherein the first subframe configuration is selected from a first set of subframe configurations. At 1006, the base station configures the UE with a second subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

FIG. 11 illustrates example operations 1100 for wireless communications, in accordance with aspects of the present disclosure. According to aspects, the operation 1100 may be performed by a user equipment.

The operations 1100 begin, at 1102, by participating in communications with a base station (BS) in a system that supports carrier aggregation (CA) and dynamic uplink and downlink subframe configuration based on traffic load. At 1104, the UE receives signaling configuring the UE with a first subframe configuration for communications on a primary component carrier (PCC), wherein the first subframe configuration is selected from a first set of subframe configurations. At 1106, the UE receives signaling configuring the UE with a second reference subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

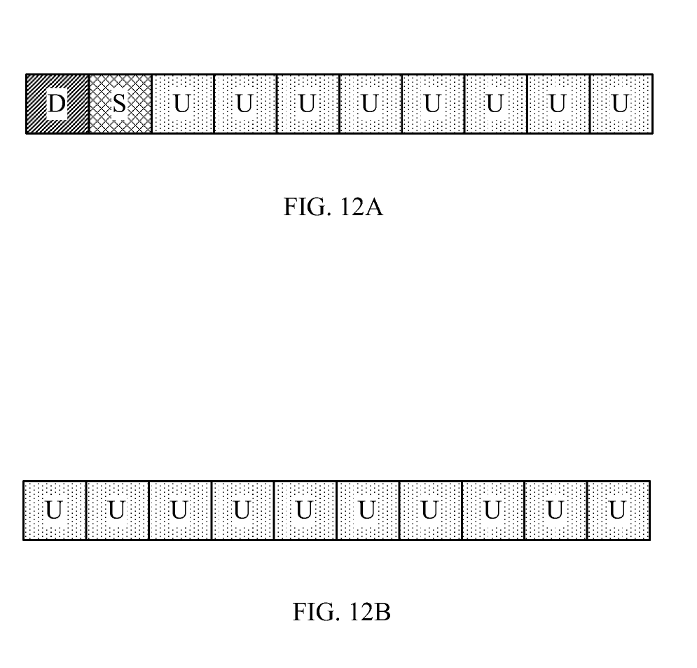

According to certain aspects, new UL-heavy TDD configurations may be defined to increase UL performance in eIMTA. As an example, a first UL-heavy configuration may be comprised of 1 DL subframe, 1 special subframe, and 8 UL subframes, (i.e., DSUUUUUUUU), as illustrated in FIG. 12A. According to certain aspects, a second example UL-heavy configuration may be comprised of UL subframes only (i.e., UUUUUUUUUU), as illustrated in FIG. 12B. According to certain aspects, the existing seven TDD configurations, as illustrated in table 800 in FIG. 8, may still be supported along with the UL-heavy TDD configurations.

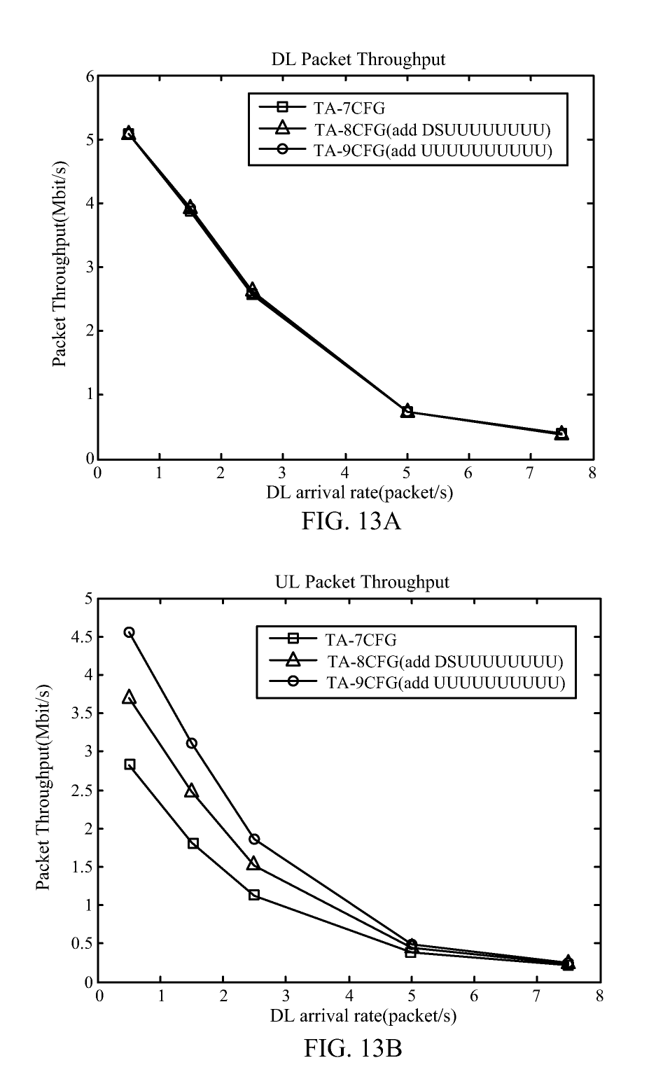

FIGS. 13A and 13B illustrate performance increases associated with the UL-heavy TDD configurations. For example, as illustrated in FIG. 13B, the subframe format illustrated in FIG. 12A may result in a gain of about 30% in UL packet throughput. Additionally, illustrated in FIG. 13B is the performance increase associated with the UL-heavy TDD configuration illustrated in FIG. 12B, which may result in a gain of about 60% in UL packet throughput. Thus, as can be seen, eIMTA performance may be increased greatly by adding UL-heavy TDD configurations while not affecting DL performance (as illustrated in FIG. 13A).

Additionally, with the addition of UL-heavy/UL-only subframe configurations, a TDD operator may be able to improve its voice over LTE (VoLTE) performance by applying frequency division duplexing (FDD) transmission time interval (TTI) bundling to a UL-only configuration, such as the configuration shown in FIG. 12B. For example, a TDD operator may be able to improve its coverage by using a UL-heavy configuration since TDD UL coverage may act as a bottleneck.

In some cases, however, when using an UL-heavy subframe configuration, the UL-TDD configuration may not have enough DL resources to carry primary synchronization signals (PSS)/secondary synchronization signals (SSS). Additionally, it may be difficult to implement HARQ and UL scheduling with the UL-heavy TDD configurations.

According to certain aspects, it may be possible to alleviate these issues by using the UL-heavy subframe configurations on the SCC in a carrier aggregation (CA) scenario by carrying dynamic signaling (e.g. HARQ and scheduling) on a primary component carrier (PCC) when an UL-heavy configuration is being used on the secondary component carrier (SCC).

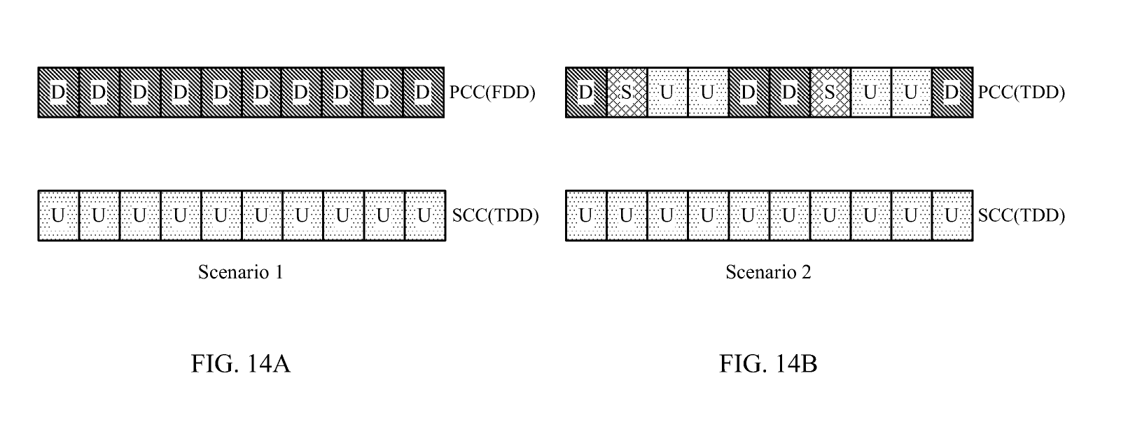

FIGS. 14A and 14B illustrate different scenarios that may exist to alleviate the potential issues with HARQ and scheduling information when using a UL-heavy TDD configuration. For example, in a first scenario as illustrated in FIG. 14A, FDD may be used on the PCC and TDD may be used on the SCC. According to certain aspects, when at least one of the existing 7 configurations is selected for the SCC, it may be the case of FDD+TDD CA. In this instance, the secondary cell (Scell) (i.e., the cell that carries the SCC) PDSCH timing may follow primary cell (Pcell) (i.e., the cell that carries the PCC). However, the Scell physical uplink control channel (PUSCH) timing may need to follow the timing of the Scell reference configuration, as discussed above. In some cases, when a UL-heavy configuration is selected for the SCC, it may be more similar to a case of FDD+FDD(UL-only) CA. Thus, according to certain aspects, PUSCH timing of SCC can reuse the existing mechanism of FDD+FDD CA for HARQ.

An additional scenario to alleviate the potential issues with HARQ and scheduling information, as illustrated in FIG. 14B, may be to use TDD on the PCC and TDD on the SCC. There may be several ways to implement this scenario. For example, in one implementation, the physical downlink shared channel (PDSCH) and PUSCH timing may follow the reference configuration of the TDD PCC. In a second implementation, when at least one of the existing seven configurations (i.e., those shown in table 800 of FIG. 8) is selected for the SCC, an existing mechanism of TDD+TDD cross-carrier scheduling may be followed. According to certain aspects, when a UL-heavy configuration is selected for the SCC, it may be similar to a case of TDD+FDD(UL-only) CA and PUSCH timing of the SCC may use a configurable reference configuration, as noted above. For example, the reference configuration may be a system information block 1 (SIB-1) subframe configuration of the PCC or an existing subframe configuration that has a high number of UL subframes (e.g., configuration #0).

As noted above, when using an UL-heavy TDD configuration, the PSS/SSS may be carried on the PCC. According to certain aspects, L1 reconfiguration signaling of the SCC may need to be extended to 4bit to accommodate the two additional UL-heavy subframe configurations. Additionally, since the HARQ timeline of CA+eIMTA is complex, it may be possible to introduce a constraint reference configuration set based on frequently selected configurations to reduce operational complexity. For example, a reference configuration subset may be semi-statically configured through radio resource control (RRC) signaling, and the corresponding HARQ operation (i.e., timing) may be tied to the configuration subset.

In some cases, as noted above, implementing an UL-heavy TDD configuration for eIMTA may greatly increase eIMTA performance. For example, it is estimated that about a 30-60% performance gain may be achieved in UL by implementing a UL-heavy TDD configuration. Additionally, in some cases, implementing a UL-heavy TDD configuration may provide more scheduling flexibility in SCC and may allow some benefits of FDD to be shared with a TDD operator. Additionally, in some cases, a demand for FDD supplemental downlink (SDL) of a shared access radio spectrum (e.g., LTE-U) may be covered by TDD. For example, the SCC may select both a DL-heavy configuration (e.g., CFG#5: DLUL:SSF=8:1:1) and an UL-heavy configuration. In some cases, selecting both a DL-heavy configuration and a UL-heavy configuration may increase eIMTA gain in the SCC since the SCC operates in a high frequency band, and therefore there may be more isolated scenarios.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for participating may comprise a transmitter/receiver (e.g., the transmitter/receiver 618) and/or an antenna(s) 620 of the eNB 610 illustrated in FIG. 6. Means for participating may also comprise a receiver/transmitter (e.g., the transmitter/receiver 654) and/or an antenna(s) 652 of the UE 650 illustrated in FIG. 6.

Means for configuring may comprise a transmitter/receiver (e.g., the transmitter/receiver 618), an antenna(s) 620, and/or one or more processors (e.g., the TX processor 616 and/or the controller/processor 675) of the eNB 610 illustrated in FIG. 6.

Means for receiving (or obtaining) may comprise a receiver (e.g., the transmitter/receiver 654) and/or an antenna(s) 652 of the UE 650 illustrated in FIG. 6 or the transmitter/receiver 618 and/or antenna(s) 620 of the eNB 610 depicted in FIG. 6.

According to certain aspects, such means may be implemented by processing systems configured to perform the corresponding functions by implementing various algorithms (e.g., in hardware or by executing software instructions) described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Furthermore, “determining” may include resolving, selecting, choosing, establishing and the like.

As used herein, the term “outputting” may involve actual transmission or output of a structure from one entity (e.g., a processing system) to another entity (e.g., an RF front end or modem) for transmission. As used herein, the term “obtaining” may involve actual receiving of a structure transmitted over the air or obtaining the structure by one entity (e.g., a processing system) from another entity (e.g., an RF front end or modem).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal 115 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer readable storage medium with instructions stored thereon separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by an apparatus such as the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a base station (BS), comprising:
participating in communications with a user equipment (UE) in a system that supports carrier aggregation (CA) and dynamic uplink and downlink subframe configuration based on traffic load;
configuring the UE with a first subframe configuration for communications on a primary component carrier (PCC), wherein the first subframe configuration is selected from a first set of subframe configurations; and
configuring the UE with a second subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

2. The method of claim 1, wherein the second subframe configuration designates all subframes as uplink subframes.

3. The method of claim 1, wherein the second subframe configuration designates one downlink subframe and one special subframe, which are followed by 8 uplink subframes.

4. The method of claim 1, wherein the PCC is utilized for frequency division duplex (FDD) communications and the SCC is utilized for time division duplex (TDD) communications.

5. The method of claim 4, wherein timing for a physical downlink shared channel (PDSCH) in the SCC is based on a reference subframe configuration in PCC, while timing for a physical uplink shared channel (PUSCH) in the SCC is based on a reference subframe configuration in SCC.

6. The method of claim 1, wherein both the PCC and SCC are utilized for time division duplex (TDD) communications.

7. The method of claim 1, wherein:
a first mechanism for timing for at least one of a physical downlink shared channel (PDSCH) or a physical uplink shared channel (PUSCH) in the SCC is used if a subframe configuration from the first set of subframe configurations is selected for communications on the SCC; and
a second mechanism for timing for at least one of a PDSCH or a PUSCH in the SCC is used if the second subframe configuration is selected for communications on the SCC.

8. The method of claim 7, wherein the second mechanism is based on a reference subframe configuration signaled in a system information block (SIB) on the PCC.

9. The method of claim 7, wherein the second mechanism is based on a reference subframe configuration with a higher number of UL SFs than a reference subframe configuration associated with the first mechanism.

10. The method of claim 1, wherein the second subframe configuration is signaled via at least 4-bit L1 reconfiguration signaling.

11. The method of claim 1, wherein a reference subframe configuration set comprises a subset of at least one of the first set of subframe configurations or the second set of subframe configurations.

12. The method of claim 11, wherein the subset is signaled semi-statically via radio resource control (RRC) signaling.

13. The method of claim 11, wherein timing for at least one of a physical downlink shared channel (PDSCH) or a physical uplink shared channel (PUSCH) is based on the subset.

14. A method for wireless communications by a user equipment (UE), comprising:
participating in communications with a base station (BS) in a system that supports carrier aggregation (CA) and dynamic uplink and downlink subframe configuration based on traffic load;
receiving signaling configuring the UE with a first subframe configuration for communications on a primary component carrier (PCC), wherein the first subframe configuration is selected from a first set of subframe configurations; and
receiving signaling configuring the UE with a second reference subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

15. The method of claim 14, wherein the second subframe configuration designates all subframes as uplink subframes.

16. The method of claim 14, wherein the second subframe configuration designates one downlink subframe and one special subframe, which are followed by 8 uplink subframes.

17. The method of claim 14, wherein the PCC is utilized for frequency division duplex (FDD) communications and the SCC is utilized for time division duplex (TDD) communications.

18. The method of claim 17, wherein timing for a physical downlink shared channel (PDSCH) in the SCC is based on a reference subframe configuration in PCC, while timing for a physical uplink shared channel (PUSCH) in the SCC is based on a reference subframe configuration in SCC.

19. The method of claim 14, wherein both the PCC and SCC are utilized for time division duplex (TDD) communications.

20. The method of claim 14, wherein:
a first mechanism for timing for at least one of a physical downlink shared channel (PDSCH) or a physical uplink shared channel (PUSCH) in the SCC is used if a subframe configuration from the first set of subframe configurations is selected for communications on the SCC; and
a second mechanism for timing for at least one of a PDSCH or a PUSCH in the SCC is used if the second subframe configuration is selected for communications on the SCC.

21. The method of claim 20, wherein the second mechanism is based on a reference subframe configuration signaled in a system information block (SIB) on the PCC.

22. The method of claim 20, wherein the second mechanism is based on a reference subframe configuration with a higher number of UL SFs than a reference subframe configuration associated with the first mechanism.

23. The method of claim 14, wherein the second subframe configuration is received via at least 4-bit L1 reconfiguration signaling.

24. The method of claim 14, wherein a reference subframe configuration set comprises a subset of at least one of the first set of subframe configurations or the second set of subframe configurations.

25. The method of claim 24, wherein the subset is signaled semi-statically via radio resource control (RRC) signaling.

26. The method of claim 24, wherein timing for at least one of a physical downlink shared channel (PDSCH) or a physical uplink shared channel (PUSCH) is based on the subset.

27. An apparatus for wireless communications, comprising:
means for participating in communications with a user equipment (UE) in a system that supports carrier aggregation (CA) and dynamic uplink and downlink subframe configuration based on traffic load;
means for configuring the UE with a first subframe configuration for communications on a primary component carrier (PCC), wherein the first subframe configuration is selected from a first set of subframe configurations; and
means for configuring the UE with a second subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.

28. An apparatus for wireless communications, comprising:
means for participating in communications with a base station (BS) in a system that supports carrier aggregation (CA) and dynamic uplink and downlink subframe configuration based on traffic load;
means for receiving signaling configuring the UE with a first subframe configuration for communications on a primary component carrier (PCC), wherein the first subframe configuration is selected from a first set of subframe configurations; and
means for receiving signaling configuring the UE with a second reference subframe configuration for communications on a secondary component carrier (SCC), wherein the second subframe configuration is selected from a second set of subframe configurations that includes at least one uplink heavy subframe configuration with a greater number of subframes designated as uplink subframes than any subframe configuration in the first set of subframe configurations.
